(19) United States
(12) Patent Application Publication
(10) Pub. No.: US 2026/0142139 A1
(43) Pub. Date: May 21, 2026

(54) COATING APPARATUS AND METHOD OF MANUFACTURING POSITIVE ELECTRODE

(71) Applicant: HONDA MOTOR CO., LTD., Tokyo (JP)

(72) Inventors: Shuga IKEDA, Saitama (JP); Tsubasa HORIE, Saitama (JP); Kohei MATSUMOTO, Saitama (JP); Shohei YOSHIDA, Saitama (JP)

(21) Appl. No.: 19/331,609

(22) Filed: Sep. 17, 2025

(30) Foreign Application Priority Data
Nov. 19, 2024 (JP) 2024-201929

(51) Int. Cl. H01M 4/04

(52) U.S. Cl. CPC H01M 4/0411

(57) ABSTRACT

Provided is a coating apparatus including: a transporter configured to continuously transport a sheet-like coating target; a first die head configured to intermittently discharge a first slurry toward a first surface region of the continuously transported coating target to form a first coating portion in a discontinuous manner; a first gas ejector configured to eject a first gas toward a terminal portion of the intermittently discharged first slurry; a second die head configured to intermittently discharge a second slurry toward a second surface region of the continuously transported coating target to form a second coating portion in a discontinuous manner; and a third die head configured to continuously discharge a third slurry toward a third surface region of the continuously transported coating target to form a third coating portion in a continuous manner.

This application is based on and claims the benefit of priority from Japanese Patent Application No. 2024-201929, filed on 19 Nov. 2024, the content of which is incorporated herein by reference.

### BACKGROUND OF THE INVENTION

### Field of the Invention

The present invention relates to a coating apparatus and a method of manufacturing a positive electrode.

### Related Art

In recent years, research and development have been conducted on batteries that contribute to improved energy efficiency, in order to ensure access to affordable, reliable, sustainable, and advanced energy for many people.

A positive electrode constituting a battery includes, for example, a positive electrode current collector, a positive electrode mixture layer disposed on the positive electrode current collector, and a frame-shaped insulating layer disposed around the positive electrode mixture layer.

Patent Document 1 discloses a method of manufacturing a bi-cell of a battery. Here, the bi-cell includes a reference surface and a first electrode formed with a specified thickness. The periphery of the reference surface is defined by at least four lateral portions. Furthermore, the at least four lateral portions include first and second lateral portions that are symmetrical with respect to the center of the reference surface, and third and fourth lateral portions that are also symmetrical with respect to the center of the reference surface. The method of manufacturing the bi-cell of the battery includes: a step of bonding a first compensation member to the first and second lateral portions either simultaneously or at different times; and a step of bonding a second compensation member to the third and fourth lateral portions either simultaneously or at different times.
Patent Document 1: U.S. Published Patent Application Publication, No. 2024/0021935, Specification

### SUMMARY OF THE INVENTION

However, in the method of manufacturing the bi-cell of the battery described in Patent Document 1, since the step of bonding the first compensation member and the step of bonding the second compensation member are not performed continuously, the manufacturing time of the bi-cell becomes prolonged.

It is an object of the present invention to provide a coating apparatus capable of shortening the manufacturing time of the positive electrode.

(1) A coating apparatus including: a transporter configured to continuously transport a sheet-like coating target; a first die head configured to intermittently discharge a first slurry toward a first surface region of the continuously transported coating target to form a first coating portion in a discontinuous manner; a first gas ejector configured to eject a first gas toward a terminal portion of the intermittently discharged first slurry; a second die head configured to intermittently discharge a second slurry toward a second surface region of the continuously transported coating target to form a second coating portion in a discontinuous manner; and a third die head configured to continuously discharge a third slurry toward a third surface region of the continuously transported coating target to form a third coating portion in a continuous manner. The first die head includes a slit-shaped first discharge port configured to discharge the first slurry in a direction substantially perpendicular to a transport direction of the coating target in the first surface region, and extending in a width direction of the transporter. The second die head includes a slit-shaped second discharge port configured to discharge the second slurry in a direction substantially perpendicular to the transport direction of the coating target in the second surface region, and extending in the width direction of the transporter. The second surface region exists upstream or downstream of the first surface region. The second coating portion is formed in a continuous manner in a region where the first coating portion is not formed. The third surface region exists on both sides of the first surface region and the second surface region, in the width direction of the transporter. The third coating portion is formed in a region where the first coating portion and the second coating portion are not formed.

(2) The coating apparatus as described in (1), in which the first gas ejector includes: a slit-shaped first ejection port configured to eject the first gas in a direction substantially parallel to the transport direction of the coating target in the first surface region, and extending in the width direction of the transporter; and a first main body and a second main body extending in the width direction of the transporter,
the first ejection port is formed between the first main body and the second main body, and
the first gas ejector is disposed such that the first ejection port is located in a vicinity of the first discharge port, and
the first main body and the second main body are respectively located on sides of the first die head and the transporter, and
the first main body extends toward a side of the first die head more than the second main body.

(3) The coating apparatus as described in (2), in which the first gas ejector further includes: a plurality of first supply ports through which the first gas is supplied; and a first gas merging section connected to the plurality of first supply ports and the first ejection port, in which the first gas supplied from the plurality of first supply ports merges, and the plurality of first supply ports are disposed in the width direction of the transporter.

(4) The coating apparatus as described in (3), in which the first supply ports and the first gas merging section have a larger dimension in a thickness direction than the first ejection port, and the first gas merging section includes an inclined surface inclined toward the first ejection port.

(5) The coating apparatus as described in (3) or (4), in which the first main body includes a groove-shaped portion extending in the width direction of the transporter,
the second main body is a plate-shaped member, and
the first gas merging section is formed between the first main body and the second main body.

(6) The coating apparatus as described in any one of (1) to (5), in which the coating apparatus further includes a second gas ejector configured to eject a second gas toward a terminal portion of the intermittently discharged second slurry, in which the second gas ejector includes a slit-shaped second ejection port configured to eject the second gas in a direction substantially parallel to the transport direction of the coating target in the second surface region, and extending in the width direction of the transporter; and a third main body and a fourth main body extending in the width direction of the transporter, the second ejection port is formed between the third main body and the fourth main body, the second gas ejector is disposed such that the second ejection port is located in a vicinity of the second discharge port, and the third main body and the fourth main body are respectively located on sides of the second die head and the transporter, and the third main body extends toward a side of the second die head more than the fourth main body.

(7) The coating apparatus as described in any one of (1) to (6), in which the first die head and the third die head perform coating at the same location in the transport direction of the coating target.

(8) A method of manufacturing a positive electrode using the coating apparatus as described in any one of (1) to (7), the method including the steps of: intermittently discharging the first slurry from the first die head toward the first surface region of the continuously transported sheet-like coating target to form the first coating portion in a discontinuous manner, intermittently discharging the second slurry from the second die head toward the second surface region of the continuously transported coating target to form the second coating portion in a discontinuous manner, and continuously discharging the third slurry from the third die head toward the third surface region of the continuously transported coating target to form the third coating portion in a continuous manner, in which the coating target is a positive electrode current collector,
the first slurry is a slurry for a positive electrode mixture layer, and the second slurry and the third slurry are slurries for an insulating layer.

(9) The method of manufacturing a positive electrode as described in (8), in which an insulating material included in the second slurry is the same as an insulating material included in the third slurry.

(10) The method of manufacturing a positive electrode as described in (8) or (9), in which the method further includes the step of dividing the coating target, on which the first coating portion, the second coating portion, and the third coating portion have been formed, in a region where the second coating portion is formed.

According to the present invention, it is possible to provide a coating apparatus capable of shortening the manufacturing time of the positive electrode.

### BRIEF DESCRIPTION OF THE DRAWINGS

FIG. 1 is a perspective view illustrating a coating apparatus according to one embodiment of the present invention;

FIG. 2 is a cross-sectional view illustrating the coating apparatus of FIG. 1;

FIG. 3 is a top view for explaining a first coating portion;

FIG. 4 is a top view illustrating trailing at a terminal portion of the first slurry;

FIG. 5 is an enlarged perspective view of a first air nozzle illustrated in FIG. 2;

FIG. 6 is an enlarged cross-sectional view of the first air nozzle illustrated in FIG. 2;

FIG. 7 is a cross-sectional view illustrating the coating apparatus of FIG. 1;

FIG. 8 is a top view for explaining a second coating portion; and

FIG. 9 is an enlarged cross-sectional view of a second air nozzle illustrated in FIG. 2.

### DETAILED DESCRIPTION OF THE INVENTION

Hereinafter, an embodiment of the present invention will be described with reference to the drawings.

### Coating Apparatus

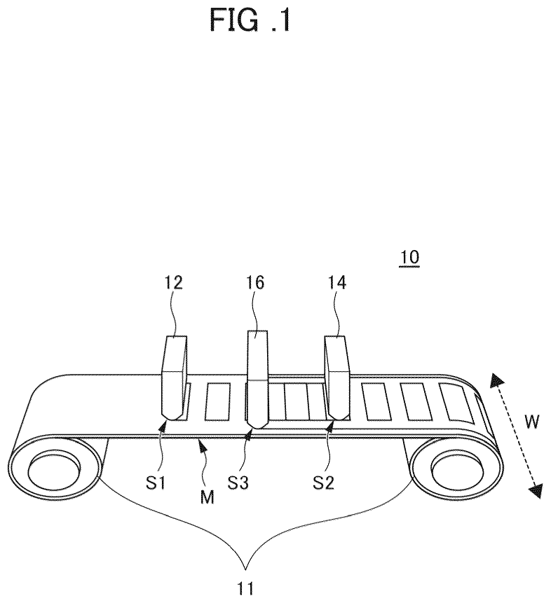

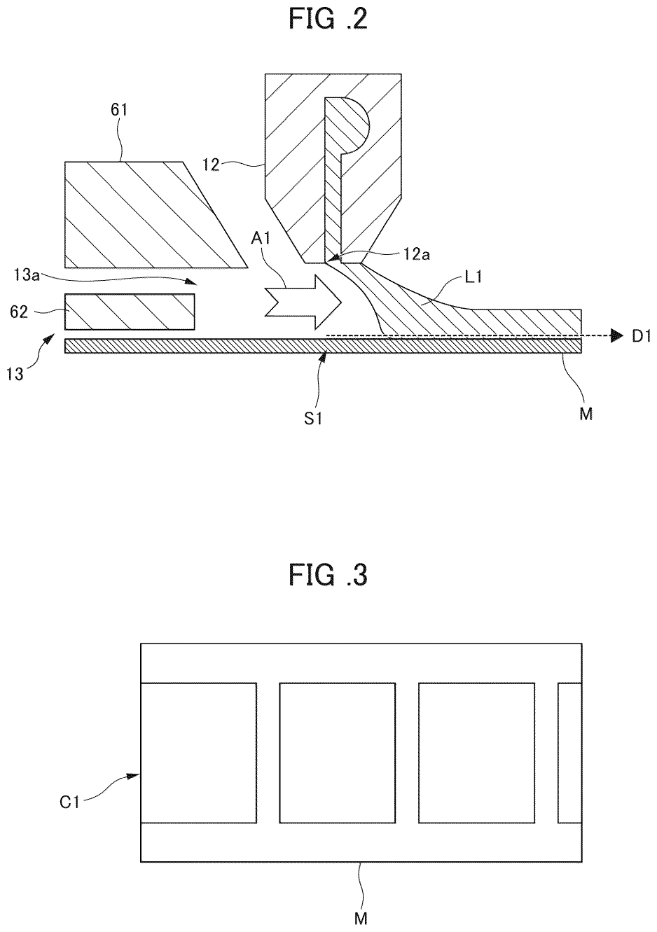

As illustrated in FIGS. 1 and 2, a coating apparatus 10 includes: a transport roller 11, serving as a transport unit configured to continuously transport a sheet-like coating target M; and a first die head 12 configured to intermittently discharge a first slurry L1 toward a first surface region S1 of the continuously transported coating target M, thereby forming a first coating portion C1 in a discontinuous manner (see FIG. 3). The coating apparatus 10 further includes a first air nozzle 13, serving as a first gas ejection unit, configured to eject a first gas A1 toward a terminal portion of the intermittently discharged first slurry L1. Accordingly, trailing at the terminal portion of the first slurry L1 discharged from the first die head 12 is suppressed, resulting in improved shape accuracy of the first coating portion C1. Here, the first die head 12 discharges the first slurry L1 in a direction substantially perpendicular to the transport direction D1 of the coating target M in the first surface region S1. The first air nozzle 13 ejects the first gas A1 in a direction substantially parallel to the transport direction D1 of the coating target M in the first surface region S1.

In order to eject the first gas A1 toward the terminal portion of the intermittently discharged first slurry L1, the timing of ejecting the first gas A1 may be adjusted based on the coating speed of the first slurry L1 (i.e., the transport speed of the coating target M), the flow velocity of the first gas A1, and the timing of stopping the discharge of the first slurry L1.

At this time, the coating speed of the first slurry L1 (i.e., the transport speed of the coating target M) is not particularly limited, but is, for example, between 10 m/min and 60 m/min inclusive. The ejection pressure of the first gas A1 is not particularly limited, but is, for example, between 10 kPa and 700 kPa inclusive. Furthermore, the viscosity of the first slurry L1 at 25° C. is not particularly limited, but is, for example, between 1000 mPa·s and 3000 mPa·s inclusive.

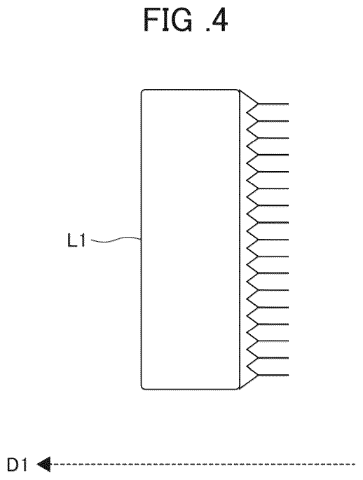

If the first gas A1 is not ejected toward the terminal portion of the intermittently discharged first slurry L1, trailing occurs at the terminal portion of the first slurry L1 discharged from the first die head 12 (see FIG. 4).

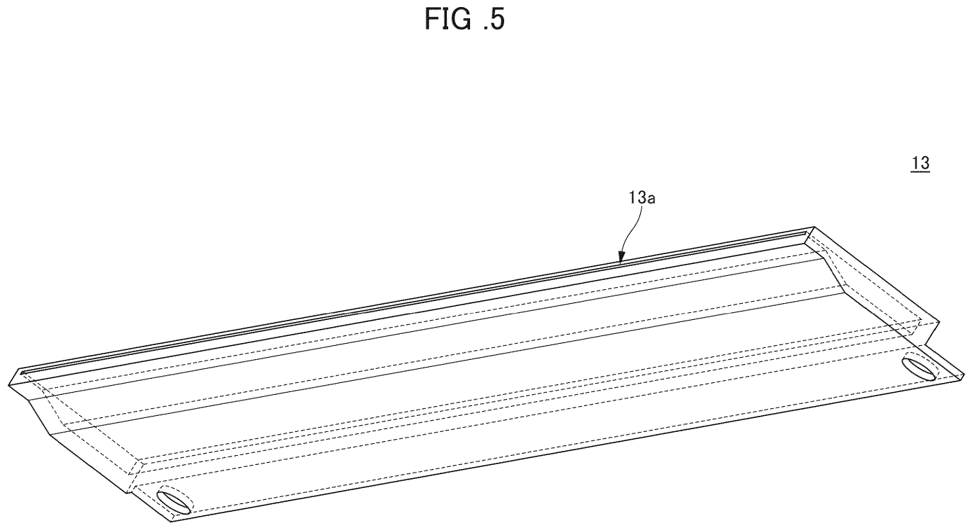

The first die head 12 includes a slit-shaped first discharge port 12a configured to discharge the first slurry L1 and extending in a width direction W of the transport roller 11 (the coating target M). The first air nozzle 13 includes a slit-shaped first ejection port 13a configured to eject the first gas A1 and extending in the width direction W of the transport roller 11 (see FIG. 5). Accordingly, the shape accuracy of the first coating portion C1 is further improved. At this time, the first ejection port 13a is disposed in the vicinity of the first discharge port 12a. The width of the first ejection port 13a is not particularly limited, but is, for example, between 500 mm and 700 mm inclusive.

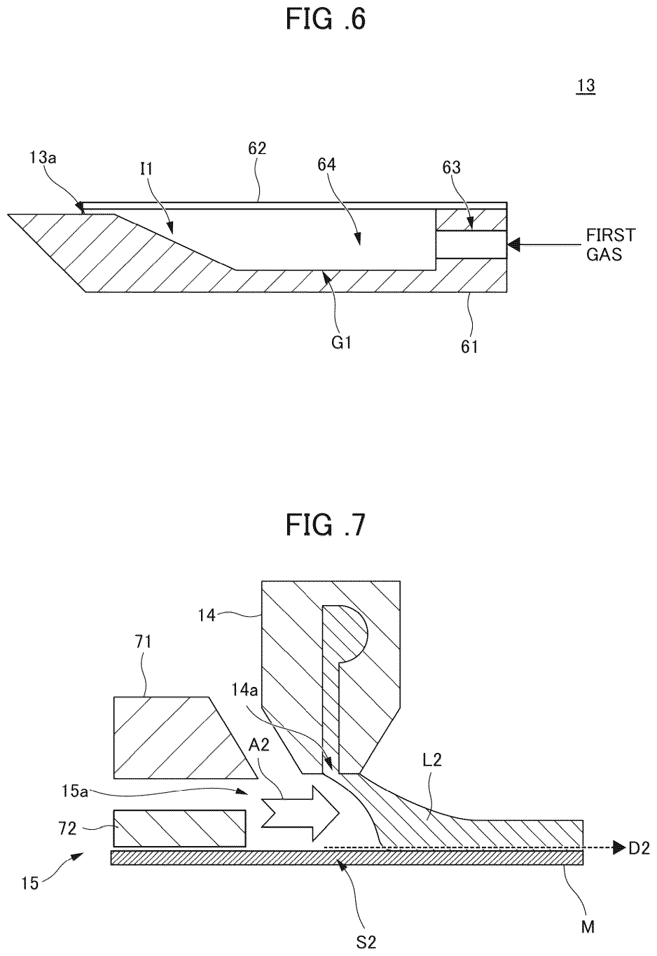

As illustrated in FIG. 6, the first air nozzle 13 includes a first main body 61 and a second main body 62, both extending in the width direction W of the transport roller 11, in which the first ejection port 13a is formed between the first main body 61 and the second main body 62. At this time, the first main body 61 and the second main body 62 are respectively disposed on the sides of the first die head 12 and the transport roller 11 (the coating target M), and the first main body 61 extends toward a side of the first die head 12 more than the second main body 62 (see FIG. 2). Therefore, the first air nozzle 13 can efficiently eject the first gas A1 by getting closer to the first discharge port 12a of the first die head 12. Furthermore, since the first main body 61 extends toward the side of the first die head 12 more than the second main body 62, the first gas A1 is guided toward the terminal portion of the intermittently discharged first slurry L1, and the first air nozzle 13 does not interfere with the transport roller 11.

The first air nozzle 13 further includes: a plurality of first supply ports 63 through which the first gas A1 is supplied from a supply source (e.g., a tank) of the first gas A1; and a first gas merging section 64 connected to the plurality of first supply ports 63 and the first ejection port 13a, in which the first gas A1 supplied from the plurality of first supply ports 63 merges. At this time, the plurality of first supply ports 63 are formed in the width direction W (depth direction in the drawing) of the transport roller 11.

The first supply ports 63 and the first gas merging section 64 have a larger dimension in a thickness direction than the first ejection port 13a, and the first gas merging section 64 includes an inclined surface I1 inclined toward the first ejection port 13a. That is, the first main body 61 includes a groove-shaped portion G1 extending in the width direction W of the transport roller 11. The second main body 62 is a plate-shaped member. The first gas merging section 64 is formed between the first main body 61 and the second main body 62. At this time, the inclination angle of the inclined surface I1 is not particularly limited, but is, for example, between 10° and 80° inclusive.

The first die head 12 is not particularly limited as long as being capable of intermittently discharging the first slurry L1 to form the first coating portion C1 in a discontinuous manner, and a known die head can be used.

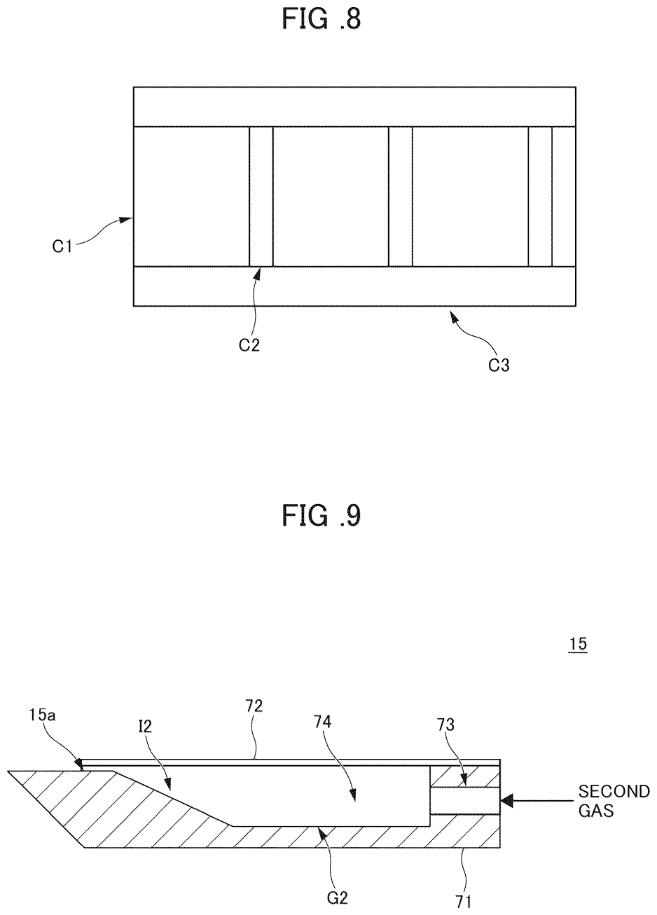

As illustrated in FIG. 7, the coating apparatus 10 further includes a second die head 14 configured to intermittently discharge a second slurry L2 toward a second surface region S2 of the continuously transported coating target M, thereby forming a second coating portion C2 in a discontinuous manner (see FIG. 8). At this time, the second surface region S2 is located downstream of the first surface region S1, and the second coating portion C2 is formed in a region where the first coating portion C1 is not formed. As a result, due to the high shape accuracy of the first coating portion C1, the shape accuracy of the second coating portion C2 is also improved. Here, the second die head 14 discharges the second slurry L2 in a direction substantially perpendicular to the transport direction D2 of the coating target M in the second surface region S2.

The coating apparatus 10 further includes a second air nozzle 15, serving as a second gas ejection unit, configured to eject a second gas A2 toward a terminal portion of the intermittently discharged second slurry L2. Accordingly, trailing at the terminal portion of the second slurry L2 discharged from the second die head 14 is suppressed, resulting in improved shape accuracy of the second coating portion C2. Here, the second air nozzle 15 ejects the second gas A2 in a direction substantially parallel to the transport direction D2 of the coating target M in the second surface region S2.

In order to eject the second gas A2 toward the terminal portion of the intermittently discharged second slurry L2, the timing of ejecting the second gas A2 may be adjusted based on the coating speed of the second slurry L2 (i.e., the transport speed of the coating target M), the flow velocity of the second gas A2, and the timing of stopping the discharge of the second slurry L2.

At this time, the coating speed of the second slurry L2 (i.e., the transport speed of the coating target M) is not particularly limited, but is, for example, between 10 m/min and 60 m/min inclusive. The ejection pressure of the second gas A2 is not particularly limited, but is, for example, between 10 kPa and 700 kPa inclusive. Furthermore, the viscosity of the second slurry L2 at 25° C. is not particularly limited, but is, for example, between 1000 mPa·s and 3000 mPa·s inclusive.

Similar to the first die head 12, the second die head 14 includes a slit-shaped second discharge port 14a configured to discharge the second slurry L2 and extending in the width direction W of the transport roller 11. Similar to the first air nozzle 13, the second air nozzle 15 includes a slit-shaped second ejection port 15a configured to eject the second gas A2 and extending in the width direction W of the coating target M. Accordingly, the shape accuracy of the second coating portion C2 is further improved. At this time, the second ejection port 15a is disposed in the vicinity of the second discharge port 14a.

As illustrated in FIG. 9, the second air nozzle 15 includes a third main body 71 and a fourth main body 72 extending in the width direction W of the transport roller 11, in which the second ejection port 15a is formed between the third main body 71 and the fourth main body 72. At this time, the third main body 71 and the fourth main body 72 are respectively disposed on the sides of the second die head 14 and the transport roller 11 (the coating target M), and the third main body 71 extends toward the side of the second die head 14 more than the fourth main body 72 (see FIG. 7). Therefore, the second air nozzle 15 can efficiently eject the second gas A2 by getting closer to the second discharge port 14a of the second die head 14. Furthermore, since the third main body 71 extends toward the side of the second die head 14 more than the fourth main body 72, the second gas A2 is guided toward the terminal portion of the intermittently discharged second slurry L2, and the second air nozzle 15 does not interfere with the transport roller 11.

The second air nozzle 15 further includes: a plurality of second supply ports 73 through which the second gas A2 is supplied from a supply source (e.g., a tank) of the second gas A2; and a second gas merging section 74 connected to the plurality of second supply ports 73 and the second ejection port 15a, in which the second gas A2 supplied from the plurality of second supply ports 73 merges. At this time, the plurality of second supply ports 73 are formed in the width direction W (depth direction in the drawing) of the transport roller 11.

The second supply ports 73 and the second gas merging section 74 have a larger dimension in a thickness direction than the second ejection port 15a, and the second gas merging section 74 includes an inclined surface I2 inclined toward the second ejection port 15a. That is, the third main body 71 includes a groove-shaped portion G2 extending in the width direction W of the transport roller 11. The fourth main body 72 is a plate-shaped member. The second gas merging section 74 is formed between the third main body 71 and the fourth main body 72. At this time, the inclination angle of the inclined surface I2 is not particularly limited, but is, for example, between 10° and 80° inclusive.

The second die head 14 is not particularly limited as long as being capable of intermittently discharging the second slurry L2 to form the second coating portion C2 in a discontinuous manner, and a known die head can be used.

As illustrated in FIG. 1, the coating apparatus 10 further includes a third die head 16 configured to continuously discharge a third slurry toward a third surface region S3 of the continuously transported coating target M, thereby forming a third coating portion C3 in a continuous manner (see FIG. 8). At this time, the third surface region S3 is located on both sides of the first surface region S1 and the second surface region S2 in the width direction W of the transport roller 11, in which the third coating portion C3 is formed in a region where the first coating portion C1 and the second coating portion C2 are not formed. Accordingly, in the case where the first slurry is a slurry for a positive electrode mixture layer, and the second slurry and the third slurry are slurries for an insulating layer, the third slurry is also discharged at the same timing as the discharge of the first slurry (and the second slurry), resulting in shortened manufacturing time for the positive electrode. At this time, the second coating portion C2 and the third coating portion C3 form an insulating layer having high shape accuracy.

The third die head 16 is not particularly limited as long as being capable of continuously discharging the third slurry to form the third coating portion C3 in a continuous manner, and a known die head can be used.

The arrangement order of the first die head 12, the second die head 14, and the third die head 16 may be appropriately changed as needed. That is, the second surface region S2 may exist upstream of the first surface region S1.

The first die head 12 and the third die head 16 may perform coating at the same location in the transport direction of the coating target M. That is, a known die head may be used to intermittently discharge the first slurry and continuously discharge the third slurry.

### Coating Method

The coating method according to the present embodiment includes a step of intermittently discharging the first slurry L1 from the first die head 12 toward the first surface region S1 of the continuously transported sheet-like coating target M to form the first coating portion C1 in a discontinuous manner, while continuously transporting the coating target M. This method can be carried out using the coating apparatus 10. At this time, the first gas A1 is ejected toward the terminal portion of the intermittently discharged first slurry L1. Accordingly, trailing at the terminal portion of the first slurry L1 discharged from the first die head 12 is suppressed, resulting in improved shape accuracy of the first coating portion C1. The first slurry L1 is discharged in a direction substantially perpendicular to the transport direction D1 of the coating target M in the first surface region S1, and the first gas A1 is ejected in a direction substantially parallel to the transport direction D1 in the first surface region S1.

The coating method of the present embodiment further includes a step of intermittently discharging the second slurry L2 from the second die head 14 toward the second surface region S2 of the continuously transported coating target M to form the second coating portion C2 in a discontinuous manner. At this time, the second surface region S2 is located downstream of the first surface region S1, and the second coating portion C2 is formed in a region where the first coating portion C1 is not formed. As a result, due to the high shape accuracy of the first coating portion C1, the shape accuracy of the second coating portion C2 is also improved. Here, the second slurry L2 is discharged in a direction substantially perpendicular to the transport direction D2 of the coating target M in the second surface region S2.

The coating method of the present embodiment may eject the second gas A2 toward the terminal portion of the intermittently discharged second slurry L2. At this time, the second gas A2 is ejected in a direction substantially parallel to the transport direction D2 of the coating target M in the second surface region S2. Accordingly, trailing at the terminal portion of the second slurry L2 discharged from the second die head 14 is suppressed, resulting in improved shape accuracy of the second coating portion C2. Here, the second gas A2 is ejected in a direction substantially parallel to the transport direction D2 of the coating target M in the second surface region S2.

The coating method of the present embodiment further includes a step of continuously discharging the third slurry from the third die head 16 toward the third surface region S3 of the continuously transported coating target M to form the third coating portion C3 in a continuous manner. At this time, the third surface region S3 is located on both sides of the first surface region S1 and the second surface region S2 in the width direction W of the transport roller 11, and the third coating portion C3 is formed in a region where the first coating portion C1 and the second coating portion C2 are not formed. Accordingly, in the case where the first slurry is a slurry for a positive electrode mixture layer, and the second slurry and the third slurry are slurries for an insulating layer, the third slurry is also discharged at the same timing as the first slurry (and the second slurry), so that when the first die head 12 and the third die head 16 perform coating at the same location in the transport direction of the coating target M, the manufacturing time of the positive electrode can be shortened. At this time, the third coating portion C3 is continuously coated, and the second coating portion C2 is intermittently coated so as to be orthogonal to the third coating portion C3, whereby the second coating portion C2 and the third coating portion C3 form an insulating layer having high shape accuracy around the first coating portion C1. If the third coating portion C3 is also intermittently coated, gaps are formed, resulting in reduced shape accuracy of the insulating layer.

The coating method of the present embodiment can also perform coating on both surfaces of the coating target M, in which the first coating portion C1, the second coating portion C2, and the third coating portion C3 may be formed integrally on both sides. The coating method of the present embodiment may further include a step of heat-drying the coating target M, on which the first coating portion C1, the second coating portion C2, and the third coating portion C3 have been formed.

The coating method of the present embodiment can be applied, for example, to the manufacture of a positive electrode constituting a battery.

### Method of Manufacturing Positive Electrode

The method of manufacturing a positive electrode of the present embodiment is a method of manufacturing a positive electrode by the coating method of the present embodiment. Here, the coating target M is a positive electrode current collector, the first slurry is a slurry for a positive electrode mixture layer, and the second slurry and the third slurry are slurries for an insulating layer. Accordingly, it is possible to obtain a positive electrode including a positive electrode mixture layer and an insulating layer with high shape accuracy.

The positive electrode current collector is not particularly limited, and examples thereof include aluminum foil.

The slurry for the positive electrode mixture layer includes, for example, a positive electrode active material. The positive electrode active material is not particularly limited, and examples thereof include ternary positive electrode materials (NCM) and lithium iron phosphate.

The slurry for the insulating layer includes an insulating material. The insulating material is not particularly limited, and examples thereof include alumina. At this time, the insulating materials included in the second slurry and the third slurry may be different, but are preferably the same. As a result, the durability of the insulating layer is improved.

The method of manufacturing a positive electrode of the present embodiment may further include a step of dividing the coating target M, on which the first coating portion C1, the second coating portion C2, and the third coating portion C3 have been formed, in a region where the second coating portion C2 is formed. The coating target M, on which the first coating portion C1, the second coating portion C2, and the third coating portion C3 have been formed, is separated into sheets, and a frame-shaped insulating layer is formed.

### Method of Manufacturing Solid-State Battery

The method of manufacturing a solid-state battery of the present embodiment includes a step of obtaining a positive electrode with the method of manufacturing a positive electrode of the present embodiment. Accordingly, short-circuiting of the solid-state battery is suppressed.

The method of manufacturing a solid-state battery of the present embodiment may further include a step of forming a solid electrolyte layer on a positive electrode mixture layer to form a positive electrode-solid electrolyte layer laminate.

The solid-state battery is not particularly limited, and examples thereof include all-solid-state lithium metal batteries. Hereinafter, an all-solid-state lithium metal battery will be described.

The all-solid-state lithium metal battery includes: a negative electrode including a negative electrode current collector and a lithium metal layer; a positive electrode including a positive electrode current collector and a positive electrode mixture layer; and a solid electrolyte layer.

The negative electrode current collector is not particularly limited, and examples thereof include copper foil.

The positive electrode mixture layer includes a positive electrode active material, and may further include a solid electrolyte, a conductive additive, a binder, and the like. The positive electrode active material is not particularly limited as long as being capable of absorbing and releasing lithium ions, and examples thereof include lithium nickel cobalt manganese composite oxide. The solid electrolyte is not particularly limited as long as being lithium-ion conductive, and examples thereof include oxide-based electrolytes and sulfide-based electrolytes. The conductive additive is not particularly limited as long being electronically conductive, and examples thereof include carbon black. The binder is not particularly limited as long as being capable of improving binding performance, and examples thereof include styrene-butadiene rubber.

The positive electrode current collector is not particularly limited, and examples thereof include aluminum foil.

The solid electrolyte layer includes a solid electrolyte, and may further include a binder and the like. The solid electrolyte is not particularly limited as long as being lithium-ion conductive, and examples thereof include inorganic solid electrolytes such as oxide-based electrolytes and sulfide-based electrolytes. The binder is not particularly limited as long as being capable of improving binding performance, and examples thereof include styrene-butadiene rubber.

An intermediate layer with a function of uniformly depositing lithium metal may be formed between the negative electrode and the solid electrolyte layer. As a result, the interface between the intermediate layer and the solid electrolyte layer is stabilized. In this case, the all-solid-state lithium metal battery may be an anode-free battery, in which a lithium metal layer is not formed at the time of initial charging. In an anode-free battery, the lithium metal layer is formed after the initial charge/discharge cycle.

The intermediate layer includes a metal capable of alloying with lithium and amorphous carbon, and may further include a binder and the like. The metal capable of alloying with lithium and the amorphous carbon are preferably nanoparticles. Examples of metals capable of alloying with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). Examples of amorphous carbon include carbon blacks such as acetylene black, furnace black, and Ketjen black, as well as coke and activated carbon. The amorphous carbon may be soft carbon (easily graphitizable carbon), hard carbon (non-graphitizable carbon), CNT (carbon nanotube), fullerene, or graphene. The binder is not particularly limited as long as being capable of improving binding performance, and examples thereof include polyvinylidene fluoride (PVDF).

While the embodiments of the present invention have been described above, the present invention is not limited to the above embodiments, and modifications may be made to the above embodiments as appropriate within the scope of the spirit of the present invention.

### EXPLANATION OF REFERENCE NUMERALS

10: coating apparatus

11: transport roller

12: first die head

12a: first discharge port

13: first air nozzle

13a: first ejection port

14: second die head

14a: second discharge port

15: second air nozzle

15a: second ejection port

16: third die head

61: first main body

62: second main body

63: first supply port

64: first gas merging section

71: third main body

72: fourth main body

73: second supply port

74: second gas merging section

A1: first gas

A2: second gas

C1: first coating portion

C2: second coating portion

D1, D2: transport directions

G: groove-shaped portion

I: inclined surface

L1: first slurry

L2: second slurry

M: coating target

S1: first surface region

S2: second surface region

S3: third surface region

W: width direction

What is claimed is:

1. A coating apparatus, comprising:
a transporter configured to continuously transport a sheet-like coating target;
a first die head configured to intermittently discharge a first slurry toward a first surface region of the continuously transported coating target to form a first coating portion in a discontinuous manner;
a first gas ejector configured to eject a first gas toward a terminal portion of the intermittently discharged first slurry;
a second die head configured to intermittently discharge a second slurry toward a second surface region of the continuously transported coating target to form a second coating portion in a discontinuous manner; and
a third die head configured to continuously discharge a third slurry toward a third surface region of the continuously transported coating target to form a third coating portion in a continuous manner,
wherein the first die head includes a slit-shaped first discharge port configured to discharge the first slurry in a direction substantially perpendicular to a transport direction of the coating target in the first surface region, and extending in a width direction of the transporter,
the second die head includes a slit-shaped second discharge port configured to discharge the second slurry in a direction substantially perpendicular to the transport direction of the coating target in the second surface region, and extending in the width direction of the transporter,
the second surface region exists upstream or downstream of the first surface region,
the second coating portion is formed in a continuous manner in a region where the first coating portion is not formed,
the third surface region exists on both sides of the first surface region and the second surface region, in the width direction of the transporter, and
the third coating portion is formed in a region where the first coating portion and the second coating portion are not formed.

2. The coating apparatus according to claim 1,
wherein the first gas ejector includes: a slit-shaped first ejection port configured to eject the first gas in a direction substantially parallel to the transport direction of the coating target in the first surface region, and extending in the width direction of the transporter; and a first main body and a second main body extending in the width direction of the transporter,
the first ejection port is formed between the first main body and the second main body,
the first gas ejector is disposed such that the first ejection port is located in a vicinity of the first discharge port, and the first main body and the second main body are respectively located on sides of the first die head and the transporter, and
the first main body extends toward a side of the first die head more than the second main body.

3. The coating apparatus according to claim 2,
wherein the first gas ejector further includes: a plurality of first supply ports through which the first gas is supplied; and a first gas merging section connected to the plurality of first supply ports and the first ejection port, in which the first gas supplied from the plurality of first supply ports merges, and
the plurality of first supply ports are disposed in the width direction of the transporter.

4. The coating apparatus according to claim 3,
wherein the first supply ports and the first gas merging section have a larger dimension in a thickness direction than the first ejection port, and
the first gas merging section includes an inclined surface inclined toward the first ejection port.

5. The coating apparatus according to claim 3,
wherein the first main body includes a groove-shaped portion extending in the width direction of the transporter,
the second main body is a plate-shaped member, and
the first gas merging section is formed between the first main body and the second main body.

6. The coating apparatus according to claim 1, further comprising a second gas ejector configured to eject a second gas toward a terminal portion of the intermittently discharged second slurry,
wherein the second gas ejector includes a slit-shaped second ejection port configured to eject the second gas in a direction substantially parallel to the transport direction of the coating target in the second surface region, and extending in the width direction of the transporter; and a third main body and a fourth main body extending in the width direction of the transporter,
the second ejection port is formed between the third main body and the fourth main body,
the second gas ejector is disposed such that the second ejection port is located in a vicinity of the second discharge port, and the third main body and the fourth main body are respectively located on sides of the second die head and the transporter, and
the third main body extends toward a side of the second die head more than the fourth main body.

7. The coating apparatus according to claim 1,
wherein the first die head and the third die head perform coating at the same location in the transport direction of the coating target.

8. A method of manufacturing a positive electrode using the coating apparatus according to claim 1, the method comprising the steps of:
intermittently discharging the first slurry from the first die head toward the first surface region of the continuously transported sheet-like coating target to form the first coating portion in a discontinuous manner,
intermittently discharging the second slurry from the second die head toward the second surface region of the continuously transported coating target to form the second coating portion in a discontinuous manner, and
continuously discharging the third slurry from the third die head toward the third surface region of the continuously transported coating target to form the third coating portion in a continuous manner,
wherein the coating target is a positive electrode current collector,
the first slurry is a slurry for a positive electrode mixture layer, and
the second slurry and the third slurry are slurries for an insulating layer.

9. The method of manufacturing a positive electrode according to claim 8,
wherein an insulating material included in the second slurry is the same as an insulating material included in the third slurry.

10. The method of manufacturing a positive electrode according to claim 8, further comprising the step of dividing the coating target, on which the first coating portion, the second coating portion, and the third coating portion have been formed, in a region where the second coating portion is formed.
